(19) United States
(12) Patent Application Publication
(10) Pub. No.: US 2008/0075078 A1
(43) Pub. Date: Mar. 27, 2008

(54) Frame Transfer System

(76) Inventor: RINNE WATANABE, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/690,234

(22) Filed: Mar. 23, 2007

(30) Foreign Application Priority Data
Sep. 25, 2006 (JP) 2006-258262

(51) Int. Cl. H04L 12/56

(52) U.S. Cl. 370/390

(57) ABSTRACT

When are multiplexed to a line for connecting a router and a LAN switch, another VLAN is set between the router and the LAN switch. The router receives affiliation requests containing the identifiers of desired groups from a client terminal belonging to VLAN and a client terminal belonging to VLAN. The router outputs a multicast frame of the group received from a distributing server is output through the logical interface corresponding to VLAN to the LAN switch. The LAN switch copies and transmits the received multicast frame to the client terminals.

### INCORPORATION BY REFERENCE

### BACKGROUND OF THE INVENTION

1. Field of the Invention

The present invention relates to a frame transfer system, and particularly to a frame transfer system for reducing multicast traffic.

2. Description of the Related Art

Use of IP multicast has been promoted to implement content distribution such as picture distribution, etc. to plural receivers as targets on IP networks. The IP multicast is a communication system suitable for distributing the same content to plural content receivers (clients). When contents are distributed to plural clients by using a uni-cast system based on one-to-one communication, content-duplicated packets whose number is equal to the number of clients must be transmitted from a server for distributing the contents (distributing server). On the other hand, according to the IP multicast, a single packet transmitted from a distributing server is copied at a route as a relay node, whereby occurrence of content-duplicated packets can be suppressed as compared with the uni-cast.

In the IP multicast, the content transmission is carried out on a group basis, and a client who wishes to receive a content can receive the content concerned by transmitting a membership report message to an upstream router. Conversely, the client who does not need to receive any content transmits a leave group message to the router, thereby finishing the content reception.

The specification of the secession and affiliation messages (the membership report message and the leave group message) that are transmitted/received between the router and the client and used in the IPv4 network is defined in a protocol called as IGMPv3 (Internet Group Management Protocol, Version 3), for example. The message specification defined in this protocol is mainly described in “5. Description of the Protocol for Group Members” and “6. Description of the Protocol for Multicast Routers” of “(1) IETF RFC3376, Internet Group Management Protocol, Version 3.”, for example. Likewise, the specification of the secession and affiliation messages in the IPv6 network is defined by MLDv2 (Multicast Listener Discovery Version 2), for example, the specification of the message defined in this protocol is mainly described in “6. Protocol Description for Multicast Address Listeners” and “7. Protocol Description for Multicast Routers” of “(2) IETF RFC 3810, Multicast Listener Discovery Version 2 (MLDv2) for IPv6.”.

Furthermore, there is a case where a Ethernet broadcast function provided to an Ethernet switch (Ethernet is a registered trademark) described in “(4) http://erg.abdn.ac.uk/users/gorry/course/intro-pages/uni-b-mca st.html” in order to carry out the content distribution to a small number of clients in a single network. When a destination MAC address described in a reception frame is a multicast, the Ethernet switch distributes the reception frame concerned to all the broadcast domains. When a client who is not affiliated with a group receives this frame, the client discards the frame. The multicast distribution can be implemented by trusting clients as to reception or non-reception.

In the multicast distribution using the Ethernet broadcast described above, a frame is also transferred to a client who is not affiliated with a group, and thus there is a problem that the band of a network is needlessly consumed. IGMP snooping and MLD snooping are known as one of methods for solving this problem. When a switch placed between a router and a client transfers IGMP and MLD messages described in “(2) IETF RFC3810, Multicast Listener Discovery Version 2 (MLDv2) for IPv6.” And “(3) draft-ietf-magma-snoop-12.txt, Considerations for IGMP and MLD Snooping Switches.” transmitted from the client to the router, the IGMP snooping and the MLD snooping peer through the contents of the messages concerned. The messages contain information concerning a group with which the client wishes to be affiliated. The pair of the information concerned and the information on a network interface to which the message described above is input is stored by the switch. When the switch receives a packet addressed to the group described above, only the stored network interface selectively outputs a packet, thereby preventing a packet from being copied to a network interface in which no affiliate to the group exists.

### SUMMARY OF THE INVENTION

The problem of the technique described in “IETF RFC3376, Internet Group Management Protocol, Version 3.” And “(2) IETF RFC3810, Multicast Listener Discovery Version 2 (MLDv2) for IPv6.” Will be described with reference to FIG. 2.

The IPv4 multicast network shown in FIG. 2 is equipped with a multicast distributing server 201 for transmitting multicast packets, a router 202 for relaying the multicast packets, a LAN switch 203, and clients 204 and 205 for receiving the multicast packets. The respective devices are connected to one another by an Ethernet line. The clients 204 and 205 are affiliated with a multicast group G, and the multicast distributing server 201 distributes the packets to the group G. Each of the clients 204 and 205 belongs to VLAN which is identified on the basis of VLAN ID=10, VLAN ID=20, respectively.

First, the multicast distributing server 201 transmits multicast packets addressed to the group G to the router 202. Two logical interfaces corresponding to VLAN ID=10 and VLAN ID=20 respectively are set for a line connected to the Ethernet switch 203 of the router 202. When receiving a multicast packet addressed to the group G from the multicast distributing server 201, the router 202 identifies an output destination of the received packet from the destination (group G) described in the packet. In the example of FIG. 2, the two logical interfaces corresponding to VLAN ID=10 and VLAN ID=20 respectively correspond to the output destination of the packet addressed to the group G. When identifying the output destination, the router 202 copies the multicast packet to achieve the two same multicast packets, encapsulates the two the multicast packets by Ethernet headers added with tags of VLAN ID=10 and VLAN ID=20, respectively, and then outputs the multicast packets as Ethernet frames from a line connected to the LAN switch 203.

At this time, the two Ethernet frames transmitted from the router 202 are different from each other only in VLAN ID in the Ethernet headers, and identical in the other information. Therefore, in order to transmit the same data, the two frames are transmitted, and thus the band of the line is needlessly consumed. The number of copies of the multicast in the router 202 is proportional to the number of VLANs of the line for connecting the router 202 and the LAN switch 203, and thus the band of the line is oppressed more heavily as the number of VLANs is increased. The method of solving the above problem is disclosed in neither “(3) draft-ietf-magma-snoop-12.text, Considerations for IGMP and MLD Snooping Switches.” nor “(4) http://erg.abdn.ac.uk/users/gory/course/intro-pages/uni-b-mcas t.html”.

In the example of FIG. 2, two VLANs are multiplexed. However, there is a case where many VLANs are multiplexed between the router 202 and the switch 203 in such a case that a PON system is constructed under command of the switch 203.

The present invention has been implemented in view of the foregoing point, and has an object to provide a packet transfer device and a frame transfer device that can enhance a line use efficiency when VLANs are multiplexed to a line for connecting a router and a LAN switch. Furthermore, the present invention has an object to suppress occurrence of multicast copy in a router to the minimum level by setting a special VLAN between a router and a LAN switch when VLANs are multiplexed to a line for connecting the router and the LAN switch.

In order to solve the above problem, a packet transfer device according to the present invention is a packet relay device that is equipped with plural input interfaces and output interfaces, identifies at least one output interface on the basis of information in the header of a packet input from the input interface and transmits the packet to the output interface concerned, and the packet transfer device is equipped with one or both of a header information writing unit for writing copy information to the header of the packet, and a packet copy controller for copying one or plural packets to the output interface corresponding to the copy information concerned when receiving the copy information concerned.

For example when plural logical interfaces exist at the output interface and at least two logical interfaces out of the logical interfaces are identified as output logical interfaces, one frame in which the copy information is written is transmitted to the output interface. The copy information is a value indicating plural output logical interfaces, for example. The frame transfer device is equipped with a destination identifying circuit for identifying one or plural output interfaces for a frame input from an input interface on the basis of the copy information and the header information, for example. The copy information is VLAN ID of VLAN Tag described in IEEE802.1Q, for example.

According to the solving means of this invention, there is provided a frame transfer system comprising:

a first transfer device for transferring a multicast frame from a distributing server; and

a second transfer device that is connected to the first transfer device through a first interface and transfers the multicast frame received from the first transfer device to a first client terminal belonging to a first virtual network and a second client terminal belonging to a second virtual network, wherein

a first logical interface corresponding to the first virtual network, a second logical interface corresponding to the second virtual network and a third logical interface corresponding to a third virtual network between the first transfer device and the second transfer device are set at the first interface connected to the second transfer device in the first transfer device,

the first transfer device receives a first affiliation request containing an identifier of a desired group from the first client terminal belonging to the first virtual network and, receives a second affiliation request containing the identifier of the group from the second client terminal belonging to the second virtual network, and

the first transfer device outputs the multicast frame of the group received from the distributing server through the third logical interface corresponding to the third virtual network to the second transfer device, and

the second transfer device copies the received multicast frame and transmits the copied multicast frames to the first and second client terminal.

### BRIEF DESCRIPTION OF THE DRAWINGS

FIG. 1 shows an example of a multicast network to which an embodiment of the present invention is applied;

FIG. 2 is a diagram showing the problem of the multicast network;

FIG. 3 is a diagram showing an example of the construction of an L3 switch 100 to which the embodiment is applied;

FIG. 4 shows an example of a format of a frame used in the multicast network;

FIG. 5 shows an internal frame format used in the L3 switch 100;

FIG. 6 is a diagram showing the construction of a frame transmission/reception circuit 330 constituting the L3 switch 100;

FIG. 7 is a diagram showing the construction of a destination identification portion 300 constituting the L3 switch 100;

FIG. 8 is a diagram showing an example of the construction of a search mode table;

FIG. 9 is a diagram showing the construction of a table search portion 740 of the L3 switch 100;

FIG. 10 is a diagram showing the format of a routing table in 911 for accumulating output interface numbers used for the search of the input side;

FIG. 11 shows an example of a bit map for identifying an output destination interface number;

FIG. 12 is a diagram showing the format of a routing table out 912 for accumulating an output interface information group used for the search of the output side;

FIG. 13 is a diagram showing a rule of generating multicast MAC addresses;

FIG. 14 is a diagram showing the format of FDB in 921 for accumulating the output interface number used for the search of the input side;

FIG. 15 is a diagram showing the format of FDB out 922 for accumulating an output interface information group used for the search of the output side;

FIG. 16 is a flowchart of merge processing of the routing table 910;

FIGS. 17A and 17B are diagrams showing the process of the merge processing of the routing table in 911;

FIGS. 18A and 18B are diagrams (1) showing the process of the merge processing of the routing table out 912;

FIGS. 19A and 19B are diagrams (2) showing the process of the merge processing of the routing table out 912;

FIGS. 20A to 20C are diagrams showing the processing of the merge processing of FDB in 921;

FIGS. 21A to 21C are diagrams showing the process of the merge processing of FDB out 922;

FIG. 22 is a diagram showing an example of a command for setting the routing table 910; and

FIG. 23 is a diagram showing an example of a command for setting FDB 920.

### DETAILED DESCRIPTION OF THE PREFERRED EMBODIMENTS

Preferred embodiments according to the present invention will be described hereunder with reference to the accompanying drawings.

### 1. System Construction

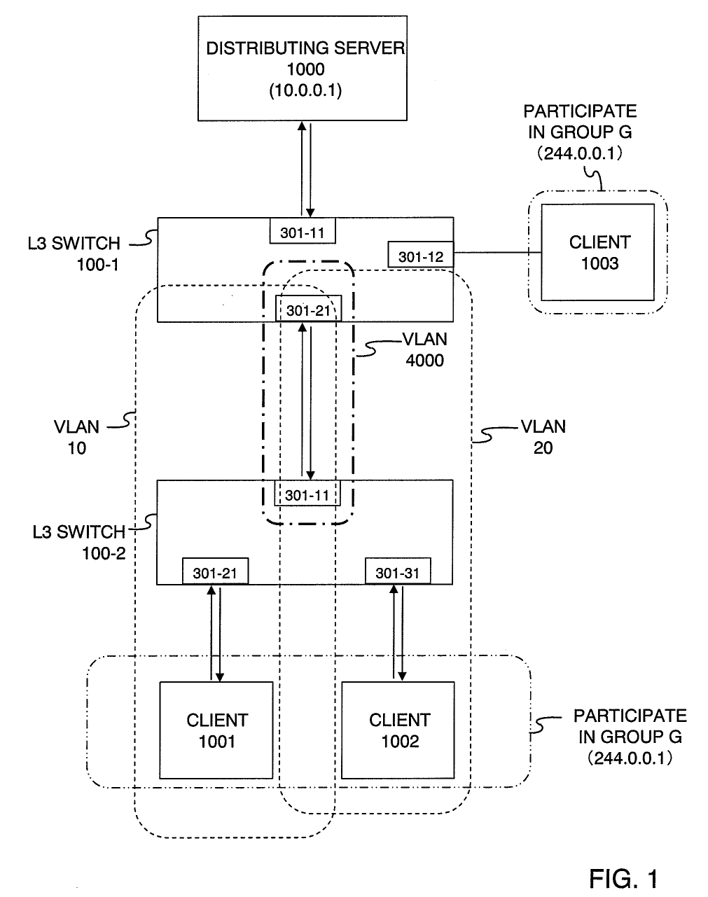

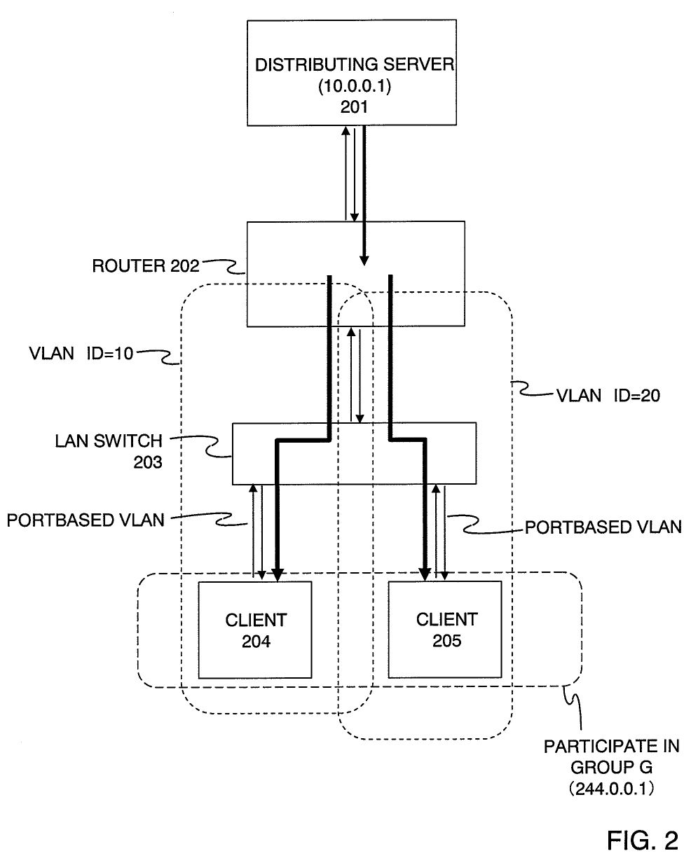

FIG. 1 is a diagram showing the construction of a network according to an embodiment.

A network system includes a distributing server 1000, an L3 switch (first transfer device) 100-1, an L3 switch (second transfer device) 100-2, and client terminals (hereinafter referred to as client) 1001, 1002. The network system is an IPv4 multicast network in which the distributing server 1000 and the clients 1001, 1002 are connected to each other through the L3 switch 100-1 and the L3 switch 100-2 having the function of this embodiment. Each L3 switch holds the functions of the L3 switch 100-1 and the L3 switch 100-2, for example, and it can be brought with an IP routing function (router function) and an Ethernet switch function (switch function). In this embodiment, the L3 switch 100-1 functions as a router, and the L3 switch 100-2 functions as an Ethernet switch.

The clients 1001 and 1002 belong to VLANs (first and second virtual networks) identified by VLAN ID=10 and VLAN ID=20, respectively. These VLANs are multiplexed to a line for connecting the L3 switch 100-1 and the L3 switch 100-2. VLAN (third virtual network) identified by VLAN ID=4000 is further set as VLAN for distributing a frame addressed to the group G between the L3 switch 100-1 and the L3 switch 100-2.

The clients 1001 and 1002 are affiliated with the multicast group G (hereinafter referred to as “group G”) which is represented by an IP address 244.0.0.1, for example. The group can be represented by a MAC address in place of the IP address, or a proper group identifier may be used.

With respect to the L3 switch 100-1, the first logical interface corresponding to the first virtual network, the second logical interface corresponding to the second virtual network and the third logical interface corresponding to the third virtual network between the L3 switch 100-1 and the L3 switch 100-2 are set at the interface of the first line connected to the L3 switch 100-2. The L3 switch 100-1 receives a first affiliation request containing the identifier of a desired group from the first client terminal 1001 belonging to the first virtual network, and receives a second affiliation request containing the identifier of a group from a second client terminal 1002 belonging to the second virtual network. The L3 switch 100-1 outputs a multicast frame of the group received from the distributing server 1000 through the third logical interface corresponding to the third virtual network to the L3 switch 100-2. The L3 switch 100-2 copies the received multicast frame and transmits the multicast frames to the first and second client terminals 1001, 1002.

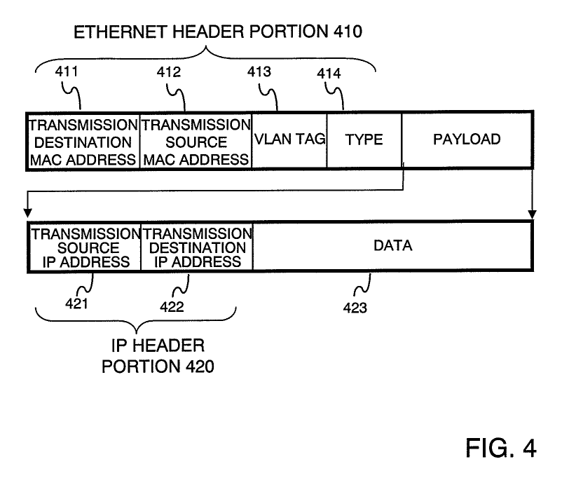

FIG. 4 is a diagram showing the format of the frame transmitted/received between equipment constituting this network.

The frame format of this embodiment has an Ethernet header portion 410 and a payload 415. The Ethernet header portion 410 contains a transmission destination MAC address 411, a transmission source MAC address 412, a VLAN tag 413 defined by IEEE 802.1Q, and a payload 415. The transmission destination MAC address 411 and the transmission source MAC address 412 are information indicating a destination and a transmission source in the data link layer, respectively. VLAN ID is described in the VLAN tag 413, and this ID is used to identify VLAN when plural VLANs are multiplexed to a single line. The VLAN tag 413 is not added when a portbased VLAN is used or when VLAN is not used. Furthermore, in the payload 415 of this format are recorded an IP header portion 420 containing a transmission source IP address 421 and a transmission destination IP address 422 as information of the network layer, and data 423 containing a UDP header, a multicast content, etc.

The multicast distributing server 1000 transmits a frame containing information to be next indicated from the line connected to the L3 switch 100-1 in order to perform multicast distribution to the clients 1001, 1002 the IP address “10.0.0.1” of the distributing server 1000 is stored at the IP address 421 of the frame transmission source, and “244.0.0.1” indicating the address to the multicast group G is stored at the IP address 422 of the transmission destination. Furthermore, an address “01:00:5E:00:00:01” generated on the basis of the IP address of the transmission destination is written at the MAC address 411 of the transmission destination, and the MAC address of the distributing server is written at the MAC address 412 of the transmission source. In this case, no VLAN tag 413 is added.

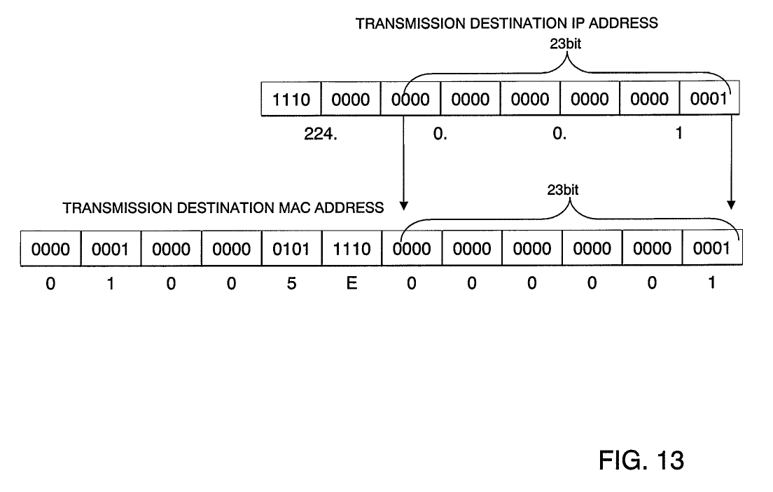

FIG. 13 is a diagram showing the MAC address of the transmission destination. Here, with respect to the transmission destination MAC address 411 in the multicast, the low 23 bits of the destination IP address 422 are copied to the low 23 bits of the destination MAC address 411 as shown in FIG. 13. The high 25 bits of the transmission destination MAC address 411 become a prefix “0000 0001 0000 0000 0101 1110 0 (binary)” indicating the multicast. When the prefix and the suffix are combined with each other, it becomes “01:00:5E:00:00:01 (hexadecimal)” as described above.

When receiving the above frame from the multicast distributing server 1000, the L3 switch 100-1 identifies the output interface from the pair of the transmission source IP address 421 and the transmission destination IP address 422. When the transmission source IP address 421 described in the frame concerned is “10.0.0.1” and the transmission destination IP address 422 is “244.0.0.1” in the L3 switch 100-1, the output interface is judged as the VLAN interface corresponding to VLAN ID=4000 and the interface (interface number 301-12) connected to the client 1003. The data construction and processing for identifying the output interface will be described later.

At this time, the frame output from the VLAN interface corresponding to VLAN ID=4000 of the L3 switch 100-1 is as follows. The IP header portion 420 and the transmission destination MAC address 411 are not varied from the state that they are received from the multicast distributing server 1000, and the VLAN tag 413 is inserted. Furthermore, for example, the MAC address of an interface (interface number 301-21) of the L3 switch 100-1 which is connected to the L3 switch 100-2 is written at the transmission source MAC address 412. Predetermined ID=4000 is written in the VLAN tag 413. Furthermore, the frame output from the interface (interface number 301-12) connected to the client 1003 is different from the frame output from the VLAN interface corresponding to VLAN ID=4000 in that no VLAN tag 413 is added and the transmission source MAC address 412 corresponds to the MAC address of the line 301-12.

The L3 switch 100-1 outputs the respective frames to the interface (interface number 301-21) connected to the L3 switch 100-2 and the interface (interface number 301-12) connected to the client 1003. The client 1003 may be omitted.

When receiving the frame concerned, the L3 switch 100-2 identifies the output destination of the frame concerned on the basis of the information of the input interface number, the transmission destination MAC address 411 and the VLAN tag 413. In this embodiment, when the L3 switch 100-2 receives from the line connected to the L3 switch 100-1 a frame in which the transmission destination MAC address 411 is “01:00:5E:00:00:01” and the VLAN tag 413 is “4000”, the L3 switch 100-2 identifies VLAN of VLAN ID=10 and VLAN of VLAN ID=20 are identified as output destinations of the frame concerned. The data construction and processing to identify the output destination will be described later. In the L3 switch 100-2, VLAN of VLAN ID=10 and VLAN of VLAN ID=20 are portbased VLANs, for example, and the L3 switch 100-2 deletes the VLAN tag 413 from the frame concerned, copies the frame concerned and outputs the frame to each VLAN.

As described above, in the network to which this embodiment is applied, a special VLAN is set between the L3 switch 100-1 and the L3 switch 100-2, and the multicast frame is multiplexed. By multiplexing the multicast frame, occurrence of multicast frame copies in the L3 switch 100-1 can be suppressed to the minimum level, and the use efficiency of the line for connecting the L3 switch 100-1 and the L3 switch 100-2 can be enhanced. No multicast copy occurs in the L3 switch 100-1, and thus there are an effect of reducing the use amount of a buffer used for packet copy and an effect that no latency occurs in the packet copy.

Furthermore, in this embodiment, VLAN ID=4000 is set as VLAN ID for the multicast between the L3 switch 100-1 and the L3 switch 100-2. However, the VLAN ID is provided as an example, and any value may be used insofar as it is made up in advance between the L3 switch 100-1 and the L3 switch 100-2. Furthermore, in the above example, the frame is multiplexed by using the VLAN tag 413. However, the frame may be multiplexed by using the other address information such as the transmission destination MAC address 411 or the like, or data.

### 2. Frame Transfer Operation in L3 Switch 100-1 (Router Function)

Next, the frame transfer operation of the L3 switch 100 according to this embodiment will be described. First, the frame transfer operation of the router function of the L3 switch 100 will be described by exemplifying the behavior of the L3 switch 100-1 of FIG. 1.

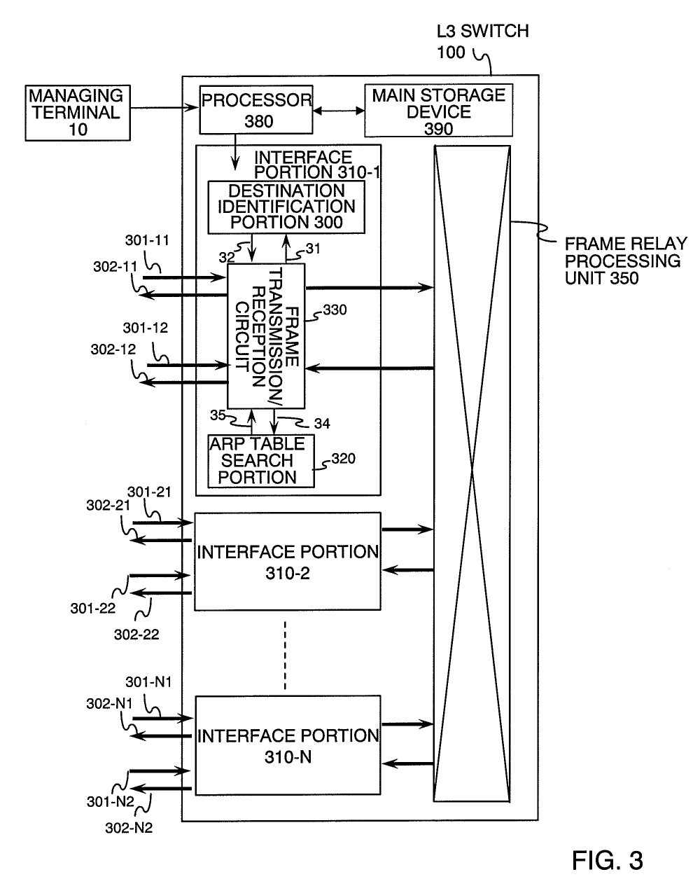

FIG. 3 is a diagram showing the internal structure of the L3 switch 100.

The L3 switch 100 has interface portions 310-i (i=1−N) of N, input/output interfaces 301-ij (i=1−N, j=1,2) of 2N accommodated in each interface portion 310, a frame relay processing unit 350 for coupling the interface portion 310-i, a processor 380, and a main storage device 390. The interface portion 310-i has a frame transmission/reception circuit 330 for executing transmission/reception processing of a frame, and a destination identification portion 300 and an Arp table search portion 320. The number of the interface portions and the number of interfaces from each interface portion may be set to proper numbers.

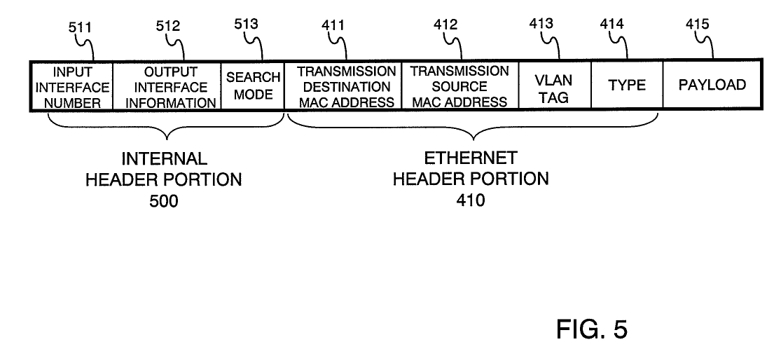

FIG. 5 shows an example of the internal frame format in the L3 switch 100.

This format is achieved by adding the frame format of FIG. 4 with an internal header portion 500. The internal header portion 500 is equipped with an input interface number 511 corresponding to the number of an interface to which a frame is input, output interface information 512 and a search mode 513. The output interface information (output interface portion bit map) 512 is used to identify the interface portion 310 of the output destination of the frame by the frame relay processing unit 350. Furthermore, the search mode 513 is used in the destination identification portion 300 to judge whether the L3 switch 100 operates as the router function or the switch function.

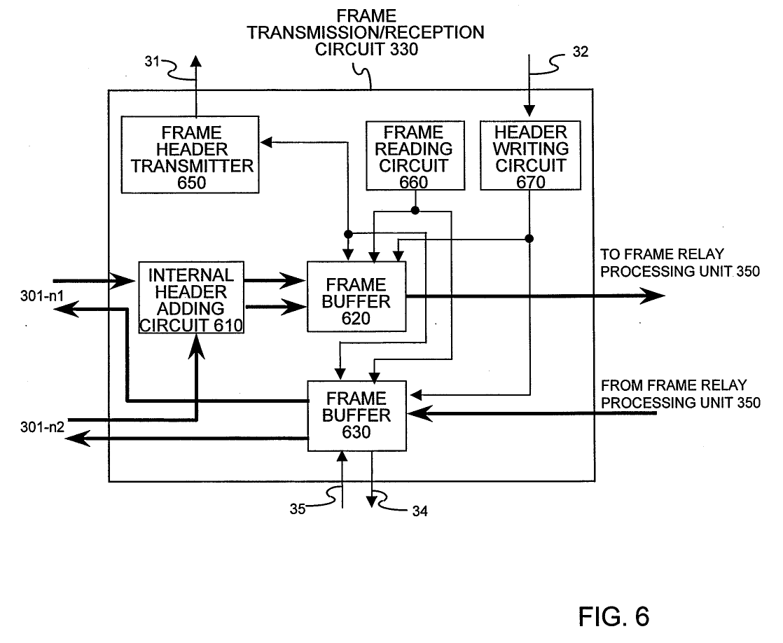

FIG. 6 is a diagram showing the construction of the frame transmission/reception circuit 330.

The frame transmission/reception circuit 330 has an internal header addition circuit 610, frame buffers 620 and 630, a frame header transmitter 650, a frame reading circuit 660 and a header writing circuit 670.

When a frame is input from the input/output interface 301, after the internal header addition circuit 610 the internal header portion 500 to the input frame concerned, and then the frame transmission/reception circuit 330 stores into the input interface number 511 the number of the interface to which the frame concerned is input and writes the frame concerned into the frame buffer 620. At this time, the values of the output interface information 512 and the search mode 513 are set to blank values (insignificant values). The frame header transmitter 650 transmits the information on the internal header portion 500, the Ethernet header portion 410 and the IP header portion 420 of the frame in the fame buffer 620 as frame header information 31 to the destination identification portion 300.

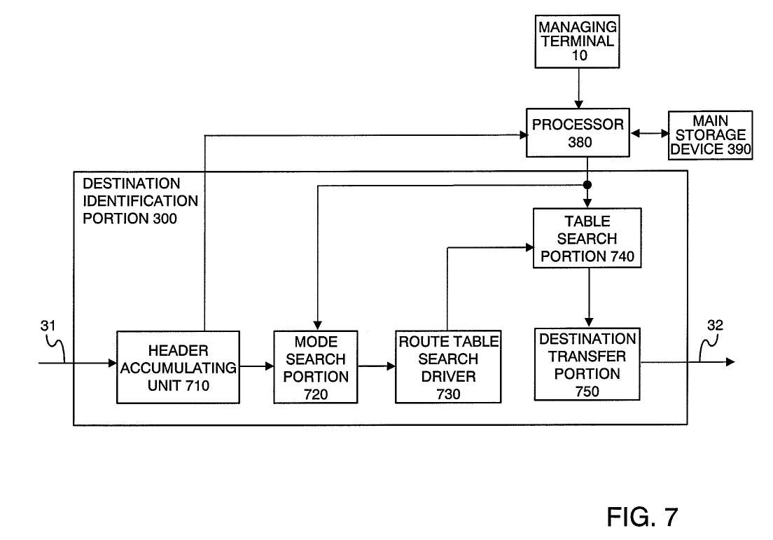

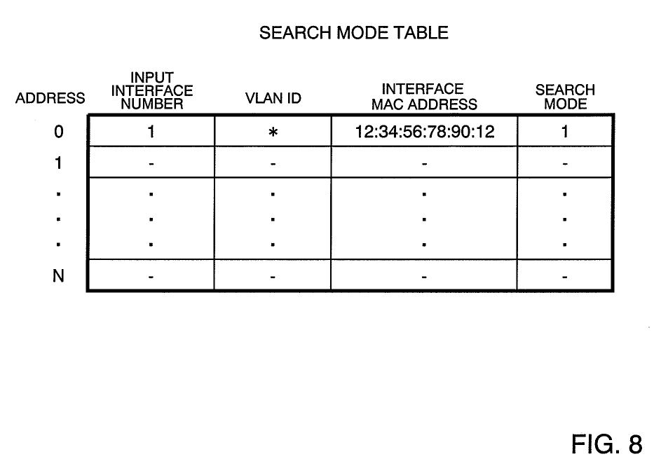

FIG. 7 is a diagram showing the construction of the destination identification portion 300, and FIG. 8 is a diagram showing the construction of the search mode table.

The destination identification portion 300 which receives the frame header information 31 from the frame transmission/reception circuit 330 executes the destination identification processing (input side destination identification processing) of the input side. Here, the details of the destination identification portion 300 will be described with reference to FIG. 7.

The destination identification portion 300 has a header accumulating unit 710 for accumulating frame header information 31, a table search portion 740 for identifying the transfer destination of the fame, a mode search portion 720 for searching and judging which one mode of the router function and the switch function the L3 switch 100 operates in, a route table search starter 730 for outputting a search instruction to the table search portion 740, and a destination transfer unit 750 for transmitting the result of the route table search as frame output destination information 32 to the header writing circuit 670.

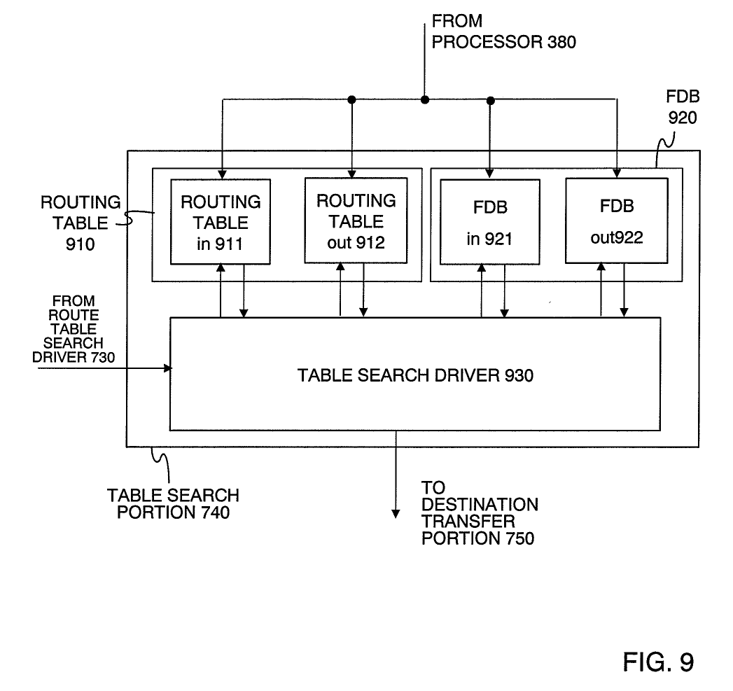

FIG. 9 is a diagram showing the construction of the table search portion 740.

As shown in FIG. 9, the table search portion 740 has a routing table 910 used for searching a frame destination when the L3 switch 100 operates as a router, FDB 920 used for searching a frame destination when the L3 switch 100 operates as a switch, and a table search driver 930 for carrying out the search operation on the table concerned. The routing table has an input side (in) 911 and an output side (out) 912. Likewise, FDB has an input side (in) 921 and an output side (out) 922.

First, when the destination identification portion 300 receives the header information 31, the destination identification portion 300 accumulates the internal header portion 500, the Ethernet header portion 410 and the IP header portion 420 into the header accumulating unit 710. When the accumulation is finished, the internal header portion 500, the Ethernet header portion 410 and the IP header 420 are transferred to the mode search portion 720. The mode search portion 720 holds the search mode table shown in FIG. 8. The search mode table stores the search mode in connection with the input interface number, VLAN ID and the interface MAC address (transmission destination MAC address). When receiving the internal header portion 500, the Ethernet header portion 410 and the IP header portion 420, the mode search portion 720 searches the search mode table by using the input interface number 511 in the internal header portion 500, VLAN ID described in the VLAN tag 413 and the transmission destination MAC address 411 as keys. A search mode of an entry in which the set of the input interface number 511, VLAN ID of the VLAN tag 413 and the interface MAC address is coincident with the set of the input interface number, VLAN ID and the interface MAC address in the search mode table is read out.

The search mode is information used in the table search portion 740, and also information for selecting a table to search the destination of the input frame. For example, the search mode is a binary value, for example, and in the case of “1”, the routing table 910 is set as a search target when the destination of the input frame is searched. On the other hand, in the case of “2”, FDB is set as a search target. In the case of the search of the routing table 910, the IP header portion 420 is used as a search key, and in the case of the search of FDB 920, the information in the Ethernet header portion 410 is used as a search key.

When a search mode is determined as a search result of the search mode table, the search mode search portion 720 writes the search mode information into the search mode 513 in the internal header portion 500, and transmits the internal header 500, the Ethernet header portion 410 and the IP header portion 420 to the table search starter 730.

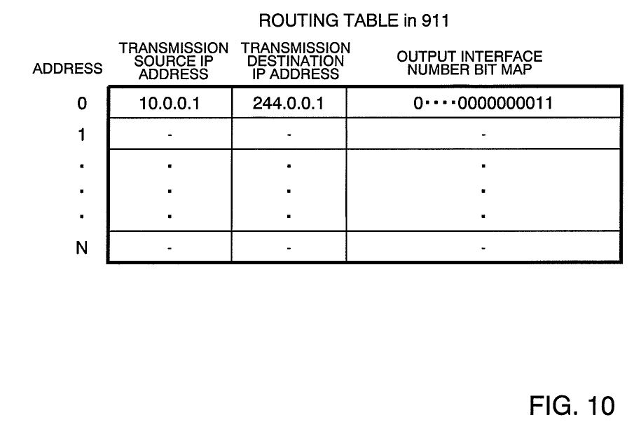

Subsequently, the table search starter 730 receiving the header information instructs the route table search portion 740 to search the routing table at the input side according to the search mode, and transmits the internal header 500, the Ethernet header portion 410 and the IP header portion 420 as search keys to the route table search portion 740. When the receiving the internal header 500, the Ethernet header portion 410 and the IP header portion 420, the route table search portion 740 reads out the search mode 513 in the internal header 500, and identifies the search target table. The details of the input side search operation will be described with reference to FIG. 9 and FIG. 10 showing the routing table in 910.

FIG. 10 shows an example of the construction of the routing table in 911.

As shown in FIG. 10, the routing table in 911 stores an output interface number bit map in connection with a transmission source IP address condition and a transmission destination IP address condition (group identifier).

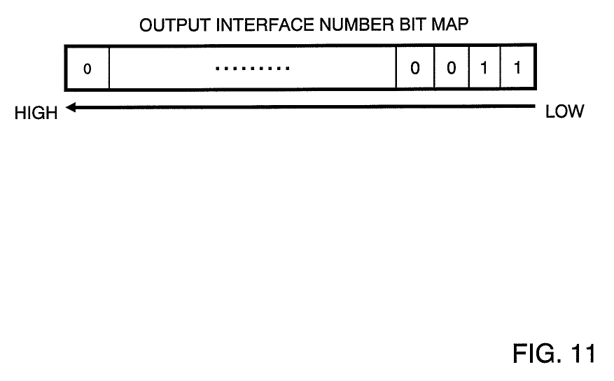

FIG. 11 is a diagram showing the output interface number bit map. The output interface number bit map is information used in the frame relay processing unit 350, and it indicates a copy destination interface portion 310 of the input frame. The lowest bit corresponds to the interface portion 310-1, a higher bit above the lowest bit corresponds to the interface portion 310-2 and the highest bit corresponds to the interface portion 310-N. The frame is transmitted to all the interface portions in which the bit is set to 1. In the case of the output interface number bit map at the address “0” in FIG. 10, the frame is transmitted to the interface portion 310-1 and the interface portion 310-2.

When receiving an input side routing table search instruction from the table search starter 730, the table search driver 930 starts to search the routing table in 911. When receiving the input side search instruction and the IP header portion 420, the table search driver 930 compares the transmission source IP address 421 in the IP header portion 420 with the transmission source IP addresses accumulated in the routing table in 911 and compares the transmission destination IP address 422 in the IP header portion 420 with the transmission destination IP address of the route table in 910. Then, the table search driver 930 reads out the output interface number bit map of the entry in which these addresses are coincident with one another. For example, in the case of the table state shown in FIG. 10, when the transmission source IP address 421 in the IP header portion 420 is “10.0.0.1” and the transmission destination IP address 422 is “244.0.0.1”, the output interface number bit map at the address “0” is read out.

Subsequently, the table search portion 740 writes the output interface number bit map as the search result of the routing table in 911 into the output interface information 512 in the internal header 500, and transmits the internal header 500 to the destination transfer unit 750. The destination transfer unit 750 transmits the internal header 500 as the frame output destination information 32 to the header writing circuit 670 in the frame transmission/reception circuit 330.

The header writing circuit 670 overwrites the internal header 500 in the frame output destination information 32 into the internal header 500 in the frame buffer 620. A packet reading circuit 660 reads out the frame accumulated from the frame buffer 620 and transmits it to the frame relay processing unit 350.

The frame relay processing unit 350 receiving the frame reads an output interface number bit map stored in the output interface number 512. On the basis of the bit map, the destination output interface portion of the received frame is checked from the lower bit, and when the bit of the bit map is set to “1”, the frame is copied and transmitted to the interface portion concerned. This operation is repeated until the reading of the highest bit of the output interface number bit map has been finished.

Each frame transmission/reception circuit 330 accumulates the frame received from the frame processing unit 350 into the frame buffer 630. The frame header transmitter 650 transmits the information of the internal header portion 500 in the frame buffer 630, the IP header portion 420 and the Ethernet header portion 410 as the frame header information 31 to the destination identification portion 300 again. The destination identification portion 300 receiving the frame header information 31 executes the destination identification processing of the output side. The destination identification processing of the output side is substantially identical to the destination identification processing of the input side, however, it is different in that a table search starter 730 outputs an output side search instruction to the route table search portion 740 and also a table search driver 930 searches a routing table out 912.

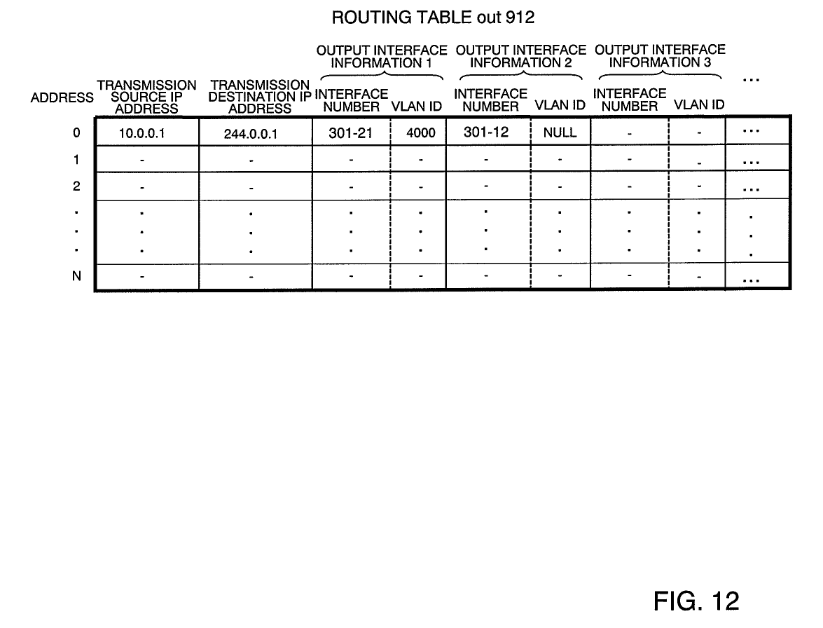

FIG. 12 shows an example of the construction of the routing table out 912.

The search operation of the output side will be described with reference to the routing table out 912 shown in FIG. 12. FIG. 12 shows an example of the routing table out 912, and the routing table out 912 stores output interface information pieces of N in connection with the transmission source IP address condition and the transmission destination IP address condition. The output interface information means that a frame is output while a VLAN tag is inserted in the frame when VLAN ID is not a blank value (NULL) in the pair of an output interface number (an interface identifier) and VLAN ID. As the interface number may be used a proper identifier in place of the number. It is meant in the case of FIG. 12 that two copies are achieved from a frame, one of the frames concerned is output from the interface of the output interface number 301-21 while a tag of VLAN ID=4000 is inserted in the frame concerned, and the other frame is output from the output interface number 301-12.

The table search driver 930 compares a combination of the transmission source IP address 421 and the transmission destination IP address 422 in the IP header portion 420, with the transmission source IP address and the transmission destination IP address of the routing table out 912. Furthermore, the table search driver 930 outputs the output interface information of an entry in which both the transmission destination IP addresses are coincident with each other.

The table search portion 740 transmits to the destination transfer portion 750 an internal header 500 in which one or plural output interface information pieces as a search result of the routing table out 912 are written. The destination transfer portion 750 transmits the output interface information in the received internal header 500 as the frame output destination information 32 to the header writing circuit 670 in the frame transmission/reception circuit 330. The header writing circuit 670 has a frame copy control function, and read out one output interface information piece in the frame output destination information 32. When the output interface number is not a blank value, the frame buffer 630 is instructed to copy the frame. Just after the copy of the frame is completed, VLAN ID in the frame output destination information 32 is inserted in the frame concerned. However, VLAN ID is NULL, no tag is added. This operation is repeated from the output interface information 1 to the output interface information N. In this embodiment, the number of the output interface information pieces is equal to 2. Therefore, two copies of the frame are achieved, one frame is output from the interface of the output interface number 301-21 while the tag of VLAN ID=4000 is inserted, and the other frame is output from the interface of the output interface number 301-12.

Here, the interface information which is not the interface number of the interface connected to the self interface portion can be neglected. Only the information of the interface connected to the self interface portion may be held. With respect to the routing table and FDB, the table search portion 740 of each interface portion 310 may have the routing table and FDB for which the same information is indicated. Furthermore, they may be stored in a main storage device 390, and each circuit interface may refer to them.

The header writing circuit 670 rewrites the transmission destination MAC address 411 in the header portion 500 to the transmission source MAC address 412. Here, the rule of generating the transmission destination MAC address 411 in the multicast will be described with reference to FIG. 13. With respect to the transmission destination IP address, an IP address is represented by a binary expression in which the IP address is sectioned every four bits and a dot-sectioned decimal notation. The transmission destination MAC address is a diagram represented by a binary expression in which the MAC address is sectioned every four bits and a hexadecimal notation of each four bits. The higher 25 bits of the transmission destination MAC address in the multicast starts from “0000:0001:0000:0000:0101:1110:0”. With respect to the lower bits, the lower 23 bits of the destination IP address are copied. In the example of FIG. 13, “000:0000:0000:0000:0000:0001” is coped. With respect to the transmission source MAC address 412, the MAC address allocated to the interface of the L3 switch 100 is written.

Furthermore, the packet reading circuit 660 reads out the accumulated frame from the frame buffer 620 and outputs it to the interface.

As described above, in the L3 switch 100-1, VLANs of VLAN ID=10 and VLAN ID=20 are multiplexed to VLAN of VLAN ID=4000, whereby the frame copy can be suppressed to the minimum level and the multicast traffic amount of the line connected to the L3 switch 100-2 can be reduced. Furthermore, as compared with the conventional technique, the effect of reducing the use amount of the buffer and the effect of reducing latency can be more expected because no multicast copy occurs.

### 3. Frame Transfer Operation in L3 Switch 100-2 (Switch Function)

Next, the frame transfer operation in the switch function of the L3 switch 100 will be described by citing the behavior of the L3 switch 100-2 shown in FIG. 1. The difference between the frame transfer operation of the router function and the switch function resides in the table search processing at the input side and the output side. The description on the same processing as the above processing is omitted. The construction of the device and the construction of the frame are the same as the L3 switch 100-1 described above.

The search processing at the input side in the switch function will be described.

When the search mode is set to “2” as a result of the mode search processing in the mode search portion 720 of the destination identification portion 300, the search target in the route table search portion 740 corresponds to FEB 920. The table search starter 730 outputs an input side FDB search instruction to the route table search portion 740 according to the search mode. Information when the Ethernet frame is transferred is accumulated in FDB (Filtering DataBase) 920, and used when the frame transfer is carried out on the basis of the information in the Ethernet header portion 410).

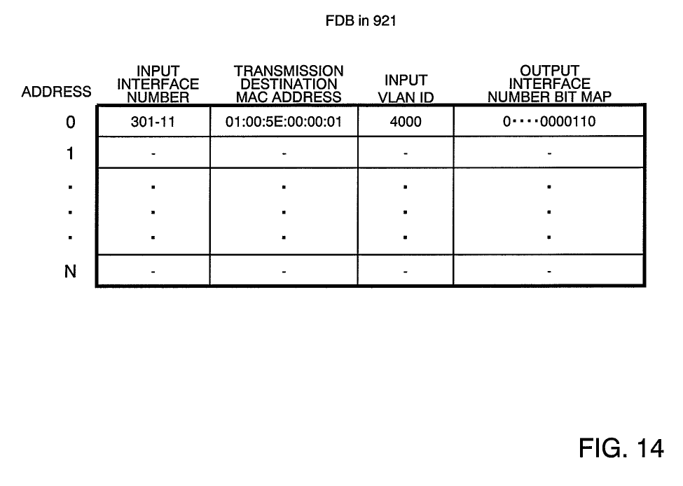

FIG. 14 shows an example of FDB 921 in used in the search processing at the input side. The FDB search processing at the input side will be described with reference to FIG. 14. As shown in FIG. 14, FDB in 921 stores the output interface number bit map in connection with the input interface number, the transmission destination MAC address (group identifier) and input VLAN ID as shown in FIG. 14.

When receiving the input side FDB search instruction from the table search starter 730, the table search driver 930 starts search of FDB in 921. The table search driver 930 compares the set of the input interface number 511, the transmission destination MAC address 411 and VLAN ID in the VLAN tag 413 with the set of the input interface number, the transmission destination MAC address and VLAN ID accumulated in FDB in 921, and reads out the output interface number bit map of the entry in which the above sets are coincident with each other. For example, when the input interface number 511 is “301-11”, the transmission destination MAC address 411 is “01:00:5E:00:00:01” and VLAN ID in the VLAN tag 413 is 4000, an output interface number bit map at the address “0” is readout. This output interface number bit map has the same meaning as the output interface number bit map accumulated in the routing table in 911, and it is used to identify the output destination interface portion 310 in the frame relay processing unit 350.

Subsequently, the table search portion 740 writes the output interface number bit map as the search result of FDB in 921 into the output interface information 512 in the internal header 500, and transmits the internal header 500 to the destination transfer portion 750. The destination transfer portion 750 transmits the internal header 500 as the frame output destination information 32 to the header writing circuit 670 in the frame transmission/reception circuit 330. Thereafter, as in the case of the router function, the frame is output to the frame relay processing unit 350, and transferred according to the output interface number bit map. Thereafter, the frame is accumulated from the frame relay processing unit 350 to the frame buffer 630, and the processing of transmitting the header information to the destination identification portion 300 is the same as the router function.

The destination identification portion 300 receiving the frame header information 31 executes the destination identification processing of the output side. The destination identification processing of the output side is substantially the same as the destination identification processing of the output side, however, it is different in that the table search starter 730 outputs an output side FDB search instruction to the route table search portion 740, and the table search driver 930 searches FDB out 922.

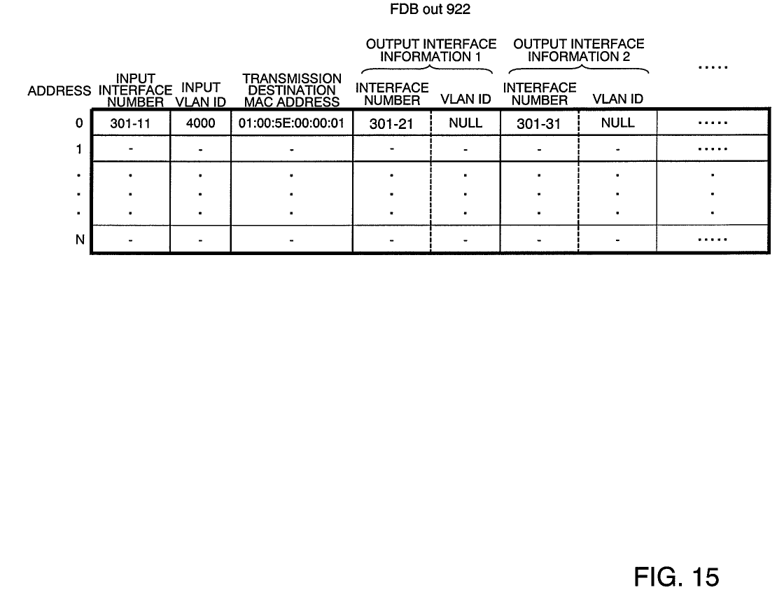

FIG. 15 shows an example of FDB out 922. The FDB search operation of the output side will be described with reference to FIG. 15.

FDB out 922 stores output interface information pieces of M in connection with the input interface number, the input VLAN ID and the transmission destination MAC address. The output interface information means that the frame is output while the VLAN tag is inserted in the frame when VLAN ID is not a blank value (NULL) in the pair of the output interface number and VLAN ID, for example. In the case of FIG. 15, it means that the frame added with no tag is output from the input/output interface “301-21” and the input/output interface “301-31”.

The table search driver 930 compares a combination of the input interface number 511, the transmission destination MAC address 411 in the Ethernet header portion 410 and VLAN ID described in the VLAN tag 413, with a combination of the input interface number, the transmission destination MAC address and VLAN ID in FDB out 922, and read out all of the output interface information of the entry in which both the combinations are coincident with each other.

The table search portion 740 transmits to the destination transfer portion 750 the internal header 500 in which the output interface information as the search result of FDB out 922 is written. The destination transfer portion 750 transmits the output interface information in the received internal header 500 as the frame output destination information 32 to the header writing circuit 670 in the frame transmission/reception circuit 330. The header writing circuit 670 reads out one output interface information piece in the frame output destination information 32, and copes the frame in the frame buffer 630 when the output interface number is not a blank value. Just after the copy of the frame is completed, VLAN ID in the frame output destination information 32 is inserted into the frame concerned. However, when VLAN ID is NULL, no tag is added. This operation is repeated from the output interface information 1 till M.

The frame reading circuit 660 reads out the accumulated frame from the frame buffer 630 and outputs it to the interface every time the copy into the frame buffer 630 by the header writing circuit 670 is finished.

As described above, in the L3 switch 100-1, VLANs of VLAN ID=10 and VLAN ID=20 are multiplexed to VLAN of VLAN ID=4000, whereby the frame copy can be suppressed to the minimum level and the multicast traffic amount of the line connected to the L3 switch 100-2 can be reduced.

### 4. Setting of Routing Table 910 in L3 Switch 100-1

As described at the start of the description of this embodiment, in this embodiment, the multicast packets flowing through the line connecting the L3 switch 100-1 and the L3 switch 100-2 can be minimized by arranging special VLAN ID between the L3 switch 100-1 and the L3 switch 100-2. In this case, the process in which the routing table 910 of the L3 switch 100-1 is set to the states of FIGS. 10 and 12 will be described.

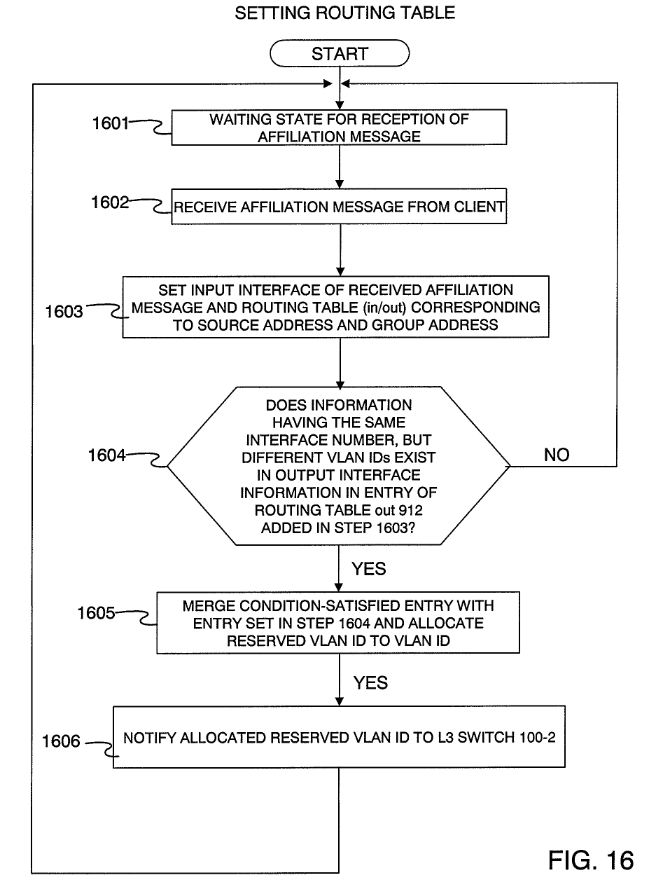

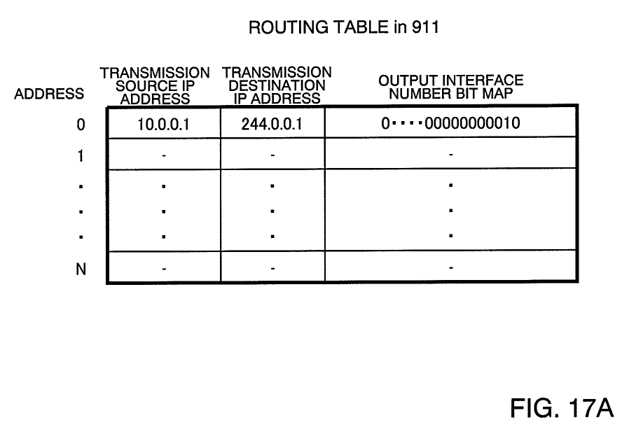

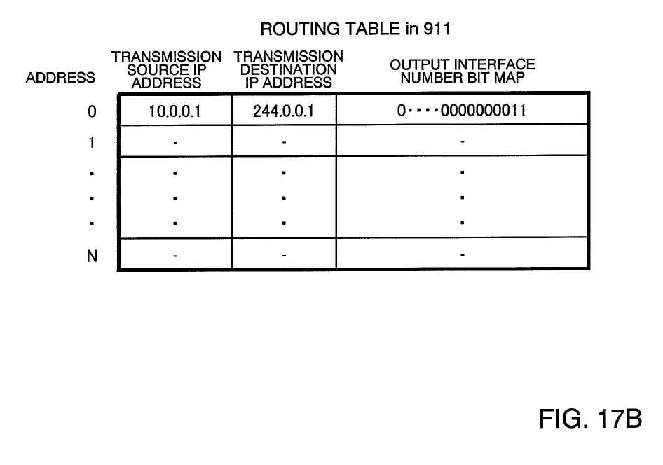

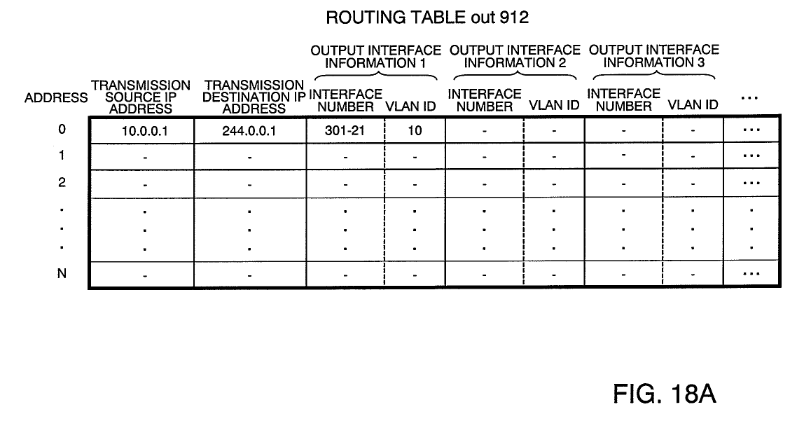

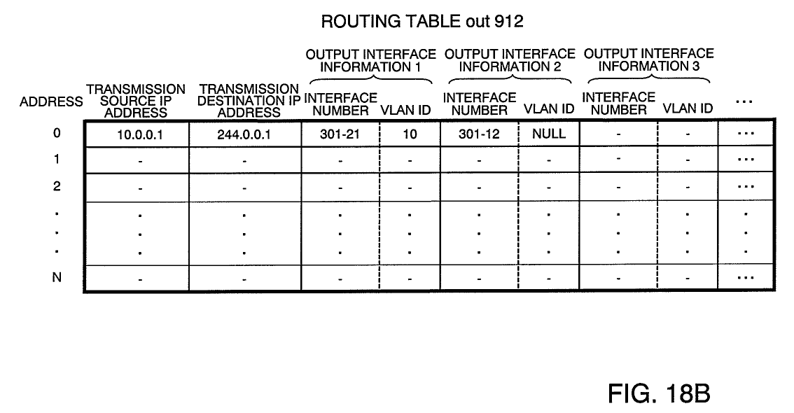

FIG. 16 is a flowchart showing the setting of the routing table, FIGS. 17A and 17B show examples of the setting of the routing table in 911, and FIGS. 18A and 18B show examples of the setting of the routing table out 912.

When multicast packets are transferred, the L3 switch 100-1 waits for a multicast group affiliating message (affiliation request) from clients 1001 to 1003 in parallel to the packet transfer operation (1601). When receiving a group participation message (affiliating message) from a client at an interface in which a multicast group management protocol such as IGMP/MLD of the L3 switch 100-1 or the like is set (1602), the processor 380 of the L3 switch 100-1 sets an entry concerning the group concerned in the routing table 910 (1603). The affiliating message contains the distribution source IP address of multicast data of a desired group, a transmission destination IP address (group identifier) and VLAN ID to which the client belongs, for example.

This setting operation will be described by specifically describing the processing when receiving an affiliation message to the group (a membership report message) address “244.0.0.1” of the multicast, the source address “10.0.0.1” of the distribution source for distributing multicast data from the client 1001 (VLAN of VLAN ID=10/interface 301-21). When receiving the affiliation message, the processor 380 of the L3 switch 100-1 writes the source address “10.0.0.1” of the distribution source contained in the affiliation message into the transmission source IP address of the routing table in 911, and writes the group address “244.0.0.1” contained in the affiliation message into the transmission IP address. Furthermore, the processor 380 writes “1” into the lower two bits of the corresponding output interface number bit map (because the interface 301-21 is connected to the interface portion 310-2). The state of the routing table in 911 at this time is shown in FIG. 17A.

Furthermore, the processor 380 writes the source address “10.0.0.1” of the distribution source, the group address “244.0.0.1”, the number 301-21 of the interface receiving the affiliation message and “10” into the transmission source IP address, the transmission destination IP address, the interface number of the output interface information 1, and VLAN ID of the output interface information 1 in the routing table out 912, respectively. The state of the routing table out 912 at this time is shown in FIG. 18A.

When renewal of the routing table 910 is completed, the processor 380 checks whether entries having the same output interface number, but different VLAN IDs exist in the output interface information of the routing table out 912 added in the flowchart 1603 (1604). At this time, in the state of the routing table out 912, only one entry exists in the output interface information as indicated in the state of the routing table out 912 of FIG. 18A. Therefore, the branch of the flowchart 1604 indicates “NO”, and thus the L3 switch 100-1 shifts to 1601.

Next, the processing when the affiliation message to the group address “244.0.0.1”, the source address “10.0.0.1” is received from the client 1003 (the interface 301-12) will be described (1602/1603). The processor 380 writes “1” to the low first bit of the output interface number bit map of the entry having the transmission source IP address “10.0.0.1” and the transmission destination IP address “244.0.0.1” which has already existed in the routing table in 911 (because the interface 301-12 is connected to the interface portion 310-1). Furthermore, it writes 301-12 into the interface number of the output interface information 2 of the transmission source IP address “10.0.0.1” and the transmission destination IP address “244.0.0.1” in the routing table out 912. At this time, the respective states of the routing table in 911 and the routing table out 912 become the states shown in FIG. 17B (corresponding to FIG. 10) and FIG. 18B, respectively. The processor 380 checks the branch of the condition of the flowchart 1604 again. In this case, when the condition is not satisfied, the processing is branched to “NO”.

Furthermore, the processing when the affiliation message to the group address “244.0.0.1” and the source address “10.0.0.1” is received from the client 1002 (VLAN of VLAN ID=20/interface 301-21) will be described (1602/1603). The processor 380 writes “1” into the low second bit of the of the output interface number bit map of the entry having the transmission source IP address “10.0.0.1” and the transmission destination IP address “244.0.0.1” which has already existed in the routing table in 911 (because the interface 301-21 is connected to the interface 310-2). In this case, “1” has been already set, and thus this processing may be omitted. The state of the routing table in 911 at this time is as shown in FIG. 17B, and it is identical to the state where the affiliation message is received from the client 1003.

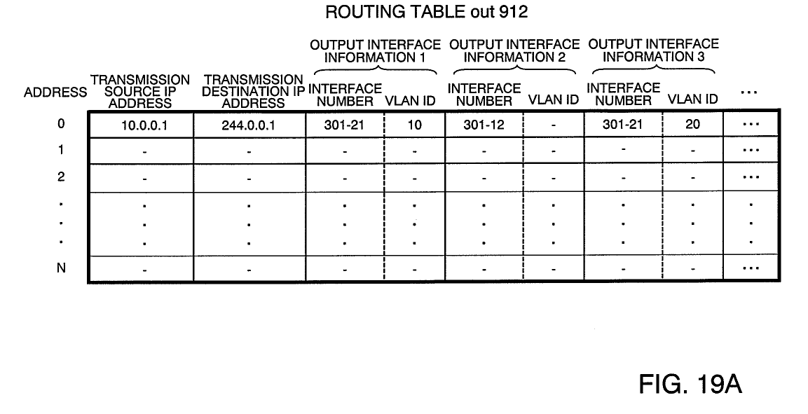

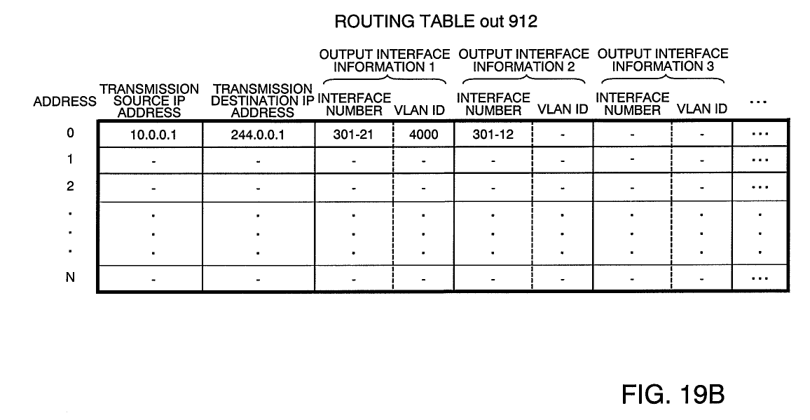

Furthermore, the processor 380 writes the number 301-21 of the interface receiving the affiliation message into the interface number of the output interface information 3 for the entry in which the transmission source IP address is “10.0.0.1” and the transmission destination IP address is “224.0.0.1”, and further writes “20” into VLAN ID of the output interface information 3. The state of the routing table out 912 at this time is shown in FIG. 19A.

The processor 380 checks the condition branch of the flowchart 1604 again. Since the routing table out 912 is under the state of FIG. 19A, the output interface information 3 and the output interface information 1 matches the condition, and thus the step 1604 is branched to “YES”, and the processor 380 shifts the processing to the entry merge processing of 1605.

VLAN ID for multicast multiplexing which is arranged between the L3 switch 100-1 and the L3 switch 100-2 in advance is accumulated in the main storage device 390. In this embodiment, for example, VLAN IDs of 4000 to 4095 are accumulated. Since the processor 380 merges the output interface information 1 with the output interface information 3, it deletes the entry of the output interface information 3 and rewrites VLAN ID of the output interface information 1. The smallest value may be selected as the value of the VLAN ID concerned from the VLAN IDs accumulated in the main storage device 390, and for example it is equal to 4000 (1605). The state of the routing table 912 out at the time when the merge is finished is shown in FIG. 19B (corresponding to FIG. 12).

Subsequently, “10” and “20” which are IDs of the original output VLANs of the transmission destination address “244.0.0.1”, and “4000” which is VLAN ID after the multiplexing are transmitted as an FDB setting message from the interface of the interface number 301-21 to the L3 switch 100-2 (1606).

### 5. Setting of FDB 920 in L3 Switch 100-2

The process in which FDB 920 of the L3 switch 100-2 is set to the states shown in FIGS. 14 and 15 will be described by exemplifying the construction of FIG. 1.

In the construction shown in FIG. 1, a multicast membership report message addressed to the L3 switch 100-1 which is transmitted from the clients 1001 and 1002 is transmitted through the L3 switch 100-2 to the L3 switch 100-1. The L3 switch 100-2 transfers the frame containing the message on the basis of the destination address of the Ethernet header. When transferring the frame concerned, the L3 switch 100-2 stares at the group address (IP address) in the affiliation message, calculates the multicast MAC address from the IP address concerned and registers it into FDB (IGMP/MLD snooping).

The L3 switch 100-2 stares at the group address “244.0.0.1” when transferring the affiliation message to the group address “244.0.0.1” and the source address “10.0.0.1” which is addressed from the client 1001 (VLAN of VLAN ID=10/interface number 301-21) to the L3 switch 100-1. The processor 380 of the L3 switch 100-2 generates “01:00:5E:00:00:01” from the group address “244.0.0.1” according to the generation rule of the multicast MAC address described above. The L3 switch 100-2 registers the interface number of the transfer destination of the affiliation message into the input interface number of FDB out 922, and registers the output destination of the MAC address as the interface number 301-21 of the output interface information into FDB out 922. Furthermore, “10” is registered into the input VLAN ID.

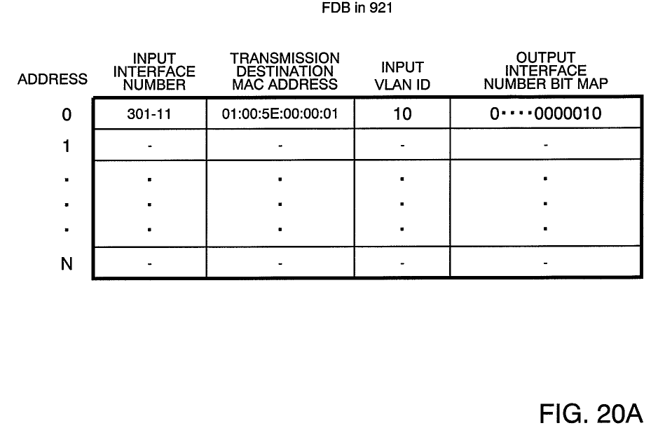

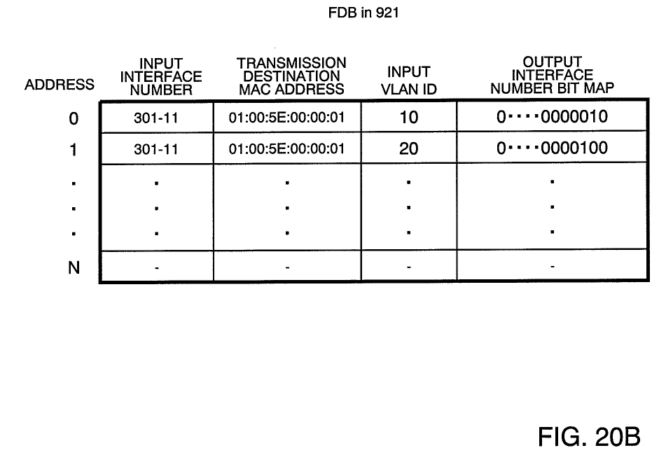

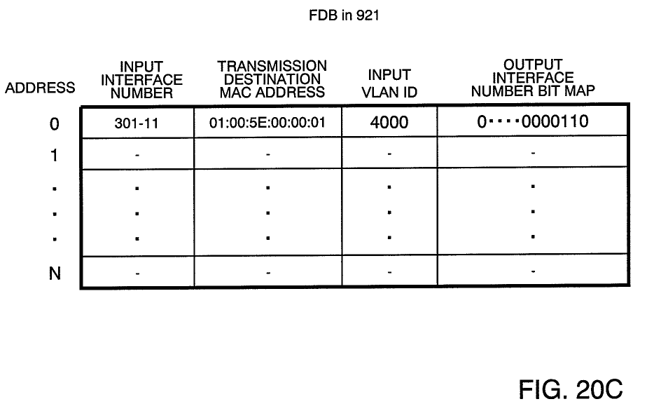

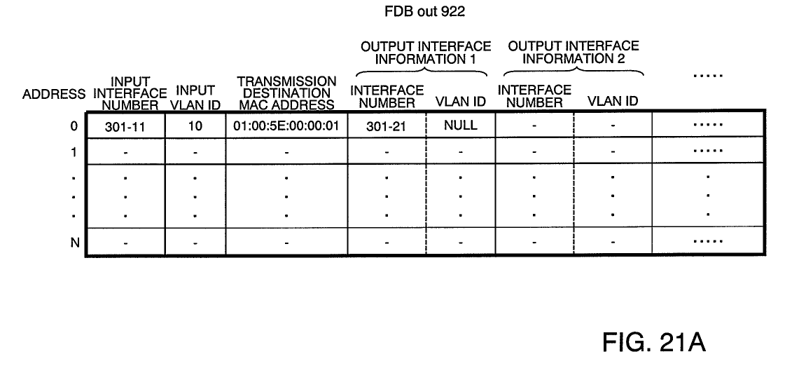

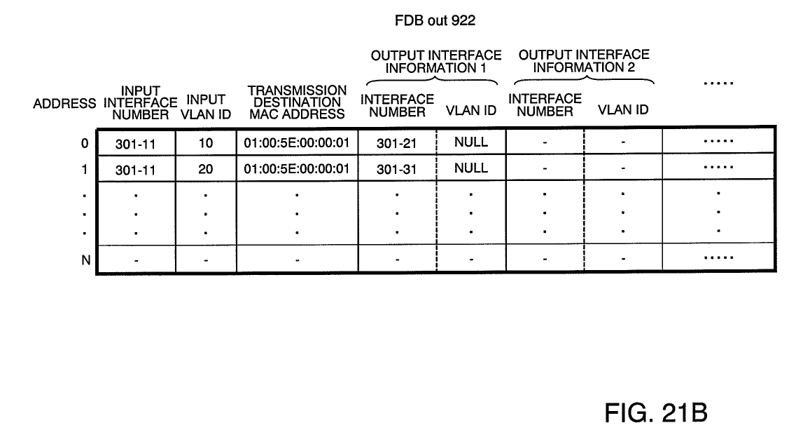

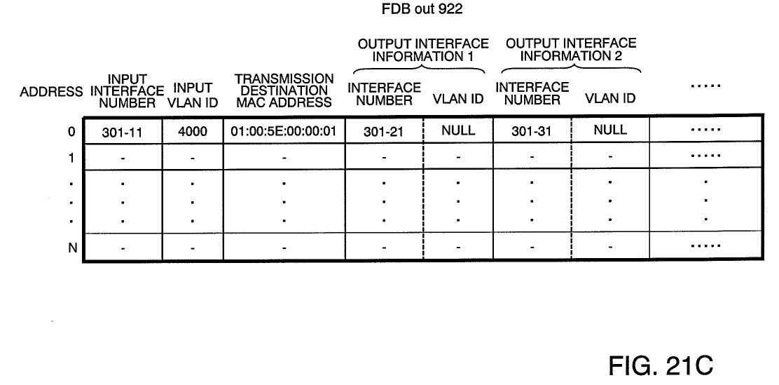

Likewise, the input interface number, the transmission destination MAC address and the input VLAN ID are registered in FDB in 921. Furthermore, “1” is written into the low second bit of the output interface number bit map (because the interface 301-21 is connected to the interface portion 310-2). At this time, the respective states of FDB in 921 and FDB out 922 are set as shown in FIGS. 20A and 21A, respectively.

Likewise, the L3 switch 100-2 stares at the group address “244.0.0.1” when transferring the affiliation message to the group address “244.0.0.1” and the source address “10.0.0.1” which is addressed from the client 1002 (the interface number 301-31) to the L3 switch 100-1. The processor 380 of the L3 switch 100-2 generates “01:00:5E:00:00:01” from the group address “244.0.0.1”, and registers each data into FDB out 922, FDB in 921 in the same manner as described above. For example, the output destination of the MAC address is registered as the interface number 301-31 into FDB 920. At this time, the states of FDB in 921 and FDB out 922 are set as shown in FIGS. 20B and 21B, respectively.

Next, the processing when an FDB setting message transmitted from the L3 switch 100-1 indicated in step 1606 of FIG. 16 is received will be described. As the content of the FDB setting message are described a group address, a source address, a VLAN ID group as a merge target and post-merge VLAN ID. In this case, a case where the group address is “244.0.0.1”, the source address is “10.0.0.1”, the merge target VLANs are VLAN ID=10 and VLAN ID=20, and the post-merge VLAN ID=4000 in the construction of FIG. 1 will be described. The L3 switch 100-2 which receives the FDB setting message of the group address “244.0.0.1”, the source address “10.0.0.1”, the merge target VLANs “VLAN ID=10” and “VLAN ID=20”, and the post-merge VLAN ID=4000 executes the following processing.

First, the processing on FDB in 921 will be described. The entry having the input VLAN ID=10 and the transmission MAC address of “01:00:5E:00:00:01” in the FDB in 921 and the entry having the VLAN ID=20 and the transmission destination MAC address of “01:00:5E:00:00:01” in the FDB in 921 are merged with each other. Under the state of FIG. 20B, the entries at the addresses 0 and 1 correspond to the above entries. In order to merge the two entries, the processor 380 calculates the logical sum of the output interface number bit maps of the addresses 0 and 1, and writes the result of the logical sum into the output interface number bit map of the address 0, for example. Subsequently, the processor 380 rewrites the input VLAN ID of the address 0 to 4000, and deletes the entry of the address 1. FIG. 20C shows the state of FDB in 921 at this time (corresponds to FIG. 14).

Next, the processing on FDB out 922 will be described. It will be described by exemplifying the same example as FDB in 921.

When receiving the FDB setting message described above, the processor 380 of the L3 switch 100-2 executes the following processing on FDB out 922 the entry in which the transmission destination MAC address is “01:00:5E:00:00:01” and the input VLAN ID is 10 or 20 is searched, and the output interface number and the input interface number of the entry concerned are stored. In the case of FIG. 20B, the entries at the addresses 0 and 1 (first and second entries) correspond to the above entries, and thus the output interface numbers of “301-21” and “301-31” which are based on the output interface number bit map and the input interface number of “301-11” are stored. For example, each information stored in the processing described above is written into the entry having the smallest address of the searched entries (in this embodiment, address 0, third entry). For example, “301-11” is written into the input interface number, “301-21” is written in the interface number of the output interface information 1 and “301-31” is written in the interface number of the output interface information 2. The VLAN IDs of the output interface information 1 and 2 are set to “NULL” because no VLAN is set in “301-21” and “301-31”. “4000” which is notified by the FDB setting message is written in the input VLAN ID, and “01:00:5E:00:00:01” is written in the transmission destination MAC address. When the writing of the entry of the address 0 is finished, the content of the entry at the address 1 is deleted, and the state of FIG. 21C is set (corresponding to FIG. 15). The information may be stored at another address, and the entries of the addresses 0 and 1 may be deleted.

As described above, by transmitting the message from the L3 switch 100-1 to the L3 switch 100-2, the L3 switch 100-2 can describe the entry for developing multicast into FDB 920. Furthermore, FDB is set by transmitting the message from the L3 switch 100-1 to the L3 switch 100-2, however, the entry of FDB 920 may be manually set by a manager.

### 6. Configuration

Next, the configuration of the L3 switch 100-1 will be described. The manager of the L3 switch 100-1 sets the routing table in 911 and the route table out 920 from the managing terminal 10.

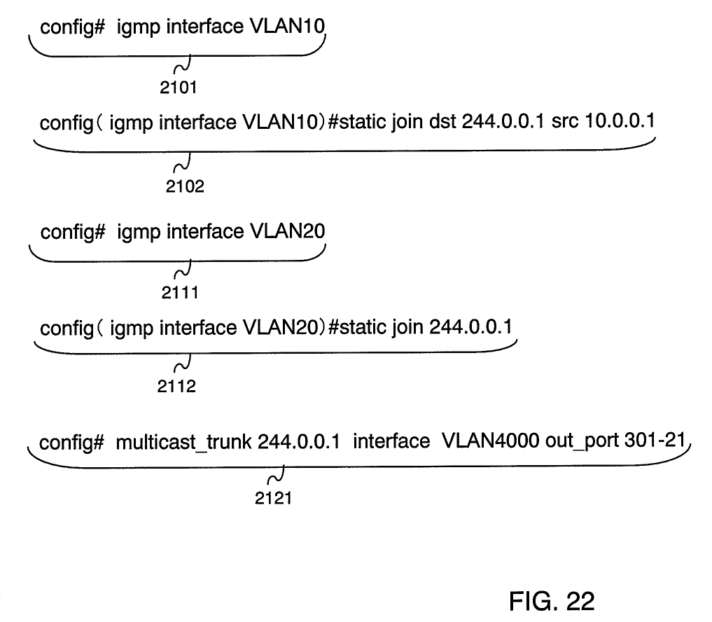

FIG. 22 shows an example of a command input to the managing terminal 10 when the route table out 920 is set.

A command 2101 of FIG. 22 is used to set an interface using IGMP. In the L3 switch 100-1 of FIG. 1, “interface VLAN 10” of the command 2101 means the interface connected to the network of VLAN ID=10. A command 2102 means that when a packet addressed to the transmission source “244.0.0.1” is received, the input packet is output to the interface VLAN 10 irrespective of reception or non-reception of an affiliation message of IGMP from the client 1001 belonging to VLAN ID=10. Likewise, commands 2111, 2112 mean that when a packet addressed to “244.0.0.1” is received, the input packet is output from the interface VLAN20.

A command 2121 means that output interfaces VLAN10, VLAN20 of a packet addressed to “244.0.0.1” set by the commands 2101 to 2112 are bundled and output to VLAN 4000. When this command 2121 is not input, the packet addressed to “244.0.0.1” is output from the VLAN 10, VLAN 20.

The processor 380 receiving the commands 2101, 2102 writes the set information into the routing table in 911 and the routing table out 912 of the address identifier 300. In an empty entry of the routing table in 911, “244.0.0.1” is written into the transmission source IP address, and “10.0.0.1” is written into the transmission source IP address. The main storage device 390 holds a data base for associating VLAN ID with the interface number at which the VLAN of the VLAN ID concerned is set. The processor 380 searches the data base to identify the interface number from the VLAN interface (VLAN ID), and writes the bit map into the output interface bit map of the routing table in 911.

The processor 380 receiving the commands 2101, 2102 writes “244.0.0.1” into the transmission destination IP address of an empty entry of the routing table out 912 and writes “10.0.0.1” into the transmission source IP address of the empty entry. Furthermore, “10” is written into VLAN ID of the output interface information 1, and “301-21” is written in the output interface number.

Likewise, with respect to the commands 2111, 2112, the same operation is carried out. However, the transmission source IP address and the transmission destination IP address are the same as the commands 2101, 2102, and VLAN 10 and VLAN 20 are set to the same interface, so that the output interface bit map of the routing table in 911 is not changed, and information of VLAN 20 is added to the output interface information 2 of the routing table out 912.

Subsequently, when receiving the command 2021, the processor 380 rewrites the routing table out 912 as follows. The entries of the output interface information of the routing table out 912 are successively referred to, entries having the output interface number of “301-21”, but different VLAN IDs are searched, and all the entries concerned are deleted. Subsequently, “301-21” is written into the output interface number of the empty entry of the output interface information, and “4000” is written into VLAN ID.

Through the above operation, the frame output from VLAN ID=10, 20 is output from the interface corresponding to VLAN ID=4000.

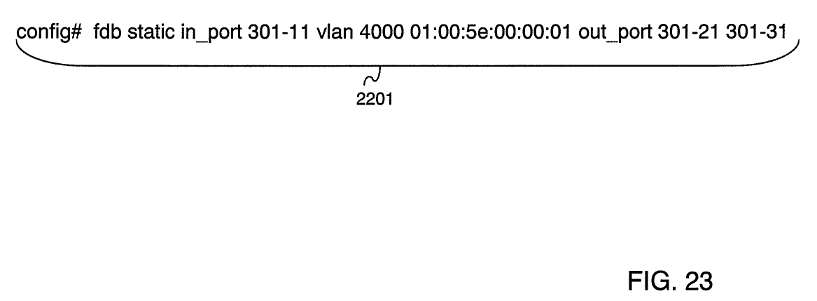

Next, the configuration of the L3 switch 100-2 will be described. The manager of the L3 switch 100-2 sets FDB 920 from the managing terminal 10. FIG. 23 shows an example of a command input to the managing terminal 10 when the output interface table 1620 is set.

A command 2100 of FIG. 23 is used to set an output interface to an input frame. “fdb static” of a command 2201 declares that a static entry is set in FDB 920. The processor 380 receiving the command from the managing terminal 10 writes “301-11” into the input interface number of an empty entry of FDB 920, writes “4000” into input VLAN ID, “01:00:5E:00:00:01” into the transmission destination MAC address, writes “301-21” into the output interface number of the output interface information 1, writes “NULL” into VLAN ID, writes “301-31” into the output interface number of the output interface information 1, and writes “NULL” into VLAN ID.

The method of developing fdb920 of the command will be described below. The processor 380 receiving the command writes “301-11” into the input interface number of FDB in 921, writes “01:00:5E:00:00:01” into the transmission destination MAC address, and writes “4000” into the input VLAN ID. The output interface number bit map is identified on the basis of the search result of the data base accumulated in the main storage device as in the case of the setting operation of the output interface number bit map of the routing table in 911. Furthermore, “301-11” is written in the input interface number of FDB out 921, “4000” is written into the input VLAN ID, and “01:00:5E:00:00:01” is written into the transmission destination MAC address. “301-21” is written into the output interface number of the output interface information 1, NULL is written into VLAN ID, “301-31” is written into the output interface number of the output interface information 2, and a blank value is written into VLAN ID.

The setting of the table entry in the L3 switch 100 and the table entry configuration in the L3 switch 100-2 are statically performed, however, they may be dynamically performed according to a protocol.

According to the present invention, it can provide a packet transfer device and a frame transfer device that can enhance a line use efficiency when VLANs are multiplexed to a line for connecting a router and a LAN switch. Furthermore, according to the present invention, it can suppress occurrence of multicast copy in a router to the minimum level by setting a special VLAN between a router and a LAN switch when VLANs are multiplexed to a line for connecting the router and the LAN switch.

What is claimed is:

1. A frame transfer system comprising:
a first transfer device for transferring a multicast frame from a distributing server; and
a second transfer device that is connected to the first transfer device through a first interface and transfers the multicast frame received from the first transfer device to a first client terminal belonging to a first virtual network and a second client terminal belonging to a second virtual network,
wherein
a first logical interface corresponding to the first virtual network, a second logical interface corresponding to the second virtual network and a third logical interface corresponding to a third virtual network between the first transfer device and the second transfer device are set at the first interface connected to the second transfer device in the first transfer device,
the first transfer device receives a first affiliation request containing an identifier of a desired group from the first client terminal belonging to the first virtual network and, receives a second affiliation request containing the identifier of the group from the second client terminal belonging to the second virtual network, and
the first transfer device outputs the multicast frame of the group received from the distributing server through the third logical interface corresponding to the third virtual network to the second transfer device, and
the second transfer device copies the received multicast frame and transmits the copied multicast frames to the first and second client terminal.

2. The frame transfer system according to claim 1, wherein
the first transfer device has a first transfer table in which one or plural output interface information pieces containing the identifier of the interface and/or the identifier of a virtual network for outputting the multicast frame of the group are stored in connection with the identifier of the group of the multicast, and
when receiving the first affiliation request and the second affiliation request through the first interface from the first client terminal and the second client terminal respectively, the first transfer device stores the identifier of the first interface and the identifier of the predetermined third virtual network in connection with the identifier of the group contained in each affiliation request into the first transfer table.

3. The frame transfer system according to claim 2, wherein the first transfer device
receives the multicast frame containing the identifier of the group from the distributing server,
refers to the first transfer table on the basis of the identifier of the group to obtain corresponding identifier of the first interface and corresponding identifier of the third virtual network, and
outputs the identifier of the third virtual network and the received multicast frame to the second transfer device through the first interface according to the obtained identifier of the first interface.

4. The frame transfer system according to claim 1, wherein
the second transfer device has a second transfer table in which one or plural identifiers of interfaces for outputting the multicast frame of the group are stored in connection with the identifier of the group of the multicast and the identifier of a virtual network, and
when receiving the first affiliation request from the first client terminal through a second interface and receiving the second affiliation request from the second client terminal through a third interface, the second transfer device stores the identifier of the second interface and the identifier of the third interface into the second transfer table in connection with the identifier of the group and the identifier of the third virtual network contained in each affiliation request.

5. The frame transfer system according to claim 4, wherein the second transfer device
receives the multicast frame containing the identifier of the group and the identifier of the third virtual network from the first transfer device,
refers to the second transfer table on the basis of the identifier of the group and the identifier of the third virtual network to obtain corresponding identifier of the second interface and corresponding identifier of the third interface, and
copies the received multicast frame and outputs the copied multicast frames to the first client terminal and the second client terminal through the second and third interfaces according to the obtained identifier of the second interface and the obtained identifier of the third interface.

6. The frame transfer system according to claim 2, wherein
the first affiliation request further contains the identifier of the first virtual network;
the second affiliation request further contains the identifier of the second virtual network;
the first transfer device:
stores first output interface information containing the identifier of the first interface and the identifier of the first virtual network into the first transfer table in connection with the identifier of the group, when the first affiliation request is received through the first interface;
stores second output interface information containing the identifier of the first interface and the identifier of the second virtual network into the first transfer table in connection with the identifier of the group, when the second affiliation request is received through the first interface; and
when plural identifiers of the same interface are stored in connection with the identifier of the same group in the first transfer table, the first transfer device stores third output interface information containing the identifier of the interface and the identifier of the predetermined third virtual network in connection with the identifier of the group into the first transfer table and deletes the first and second output interface information.

7. The frame transfer system according to claim 4, wherein
the first affiliation request further contains the identifier of the first virtual network;
the second affiliation request further contains the identifier of the second virtual network; and
when the second transfer device receives the first affiliation request from the first client terminal through the second interface, stores a first entry containing the identifier of the second interface into the second transfer table in connection with the identifier of the group and the identifier of the first virtual network,
when the second transfer device receives the second affiliation request from the second client terminal through the third interface, stores a second entry containing the identifier of the third interface into the second transfer table in connection with the identifier of the group and the identifier of the second virtual network and
when the first and second entries having the identifier of the same group are stored in the second transfer table, the second transfer device stores a third entry containing the identifier of the second interface and the identifier of the third interface into the second transfer table in connection with the identifier of the group and the identifier of the predetermined third virtual network and deletes the first and second entries.

8. The frame transfer system according to claim 7, wherein
the first transfer device transmits to the second transfer device a setting request containing the identifier of the group and the identifier of the third virtual network stored in connection with the identifier of the group, and
the second transfer device stores the identifier of the third virtual network contained in the setting request into the third entry according to the received setting request.

9. The frame transfer system according to claim 2, wherein the first transfer device has
plural interface portions for accommodating one or plural interfaces,
a relay portion for relaying a frame among the plural interface portions, and
a first input side transfer table for storing, in connection with the identifier of the group, a first output interface bit map in which each bit is constructed by plural bits which respectively correspond to the plural interface portions;
the multicast frame input from the distributing server is transferred to the interface portion corresponding to the first interface according to the first input side transfer table; and the multicast frame is transmitted through the first interface to the second transfer device according to the first transfer table at the interface portion.

10. The frame transfer system according to claim 5, wherein the second transfer device has
plural interface portions for accommodating one or plural interfaces,
a relay portion for relaying a frame among the plural interface portions, and
a second input side transfer table for storing, in connection with the identifier of the group and the identifier of a virtual network, an output interface bit map in which each bit is constructed by plural bits which respectively correspond to the plural interface portions;
the multicast frame input from the first transfer device through the first interface is copied and transferred to the interface portions corresponding to the second and third interfaces according to the input side transfer table; and
the multicast frame is transmitted to the second client terminal and the third client terminal through the second interface and the third interface according to the second transfer table at each interface portion.

11. The frame transfer system according to claim 2, wherein
the identifier of the group stored in the first transfer table is a transmission destination IP address of the multicast frame, and
the identifier of the group stored in the second transfer table is a transmission destination MAC address generated on the basis of a transmission destination IP address of the multicast frame.
